(19) United States
(12) Patent Application Publication
(10) Pub. No.: US 2017/0272259 A1
(43) Pub. Date: Sep. 21, 2017

(54) DATA COMMUNICATION

(71) Applicant: QUALCOMM Incorporated, San Diego, CA (US)

(72) Inventor: Thadi Manjunath Nagaraj, San Diego, CA (US)

(21) Appl. No.: 15/072,053

(22) Filed: Mar. 16, 2016

(51) Int. Cl. H04L 12/08; H04W 84/12; H04W 88/16; H04L 12/741

(52) U.S. Cl. CPC H04L 12/08; H04L 45/745; H04W 84/12; H04W 88/16; H04B 2201/709772; H04L 2012/5673

(57) ABSTRACT

Systems and methods utilizing a packet gate to improve communication performance with respect to a resource shared for data communication are disclosed. In embodiments, a packet gate is utilized with respect to a shared resource to improve the effective throughput and reduce packet losses with respect to a plurality of data flows sharing the resource. In operation of embodiments, data packets are dissembled into chunks and encoded, such as using forward error correction, for transmission through a switching fabric, wherein at the egress of the switching fabric the packet gate tracks the number of chunks of a packet that has been received and when a sufficient number of chunks are received drops all subsequent chunks of that packet. The admitted encoded chunks are passed through the shared resource, wherein the chunks are decoded and reassembled into the packet at the output of the shared resource of embodiments.

### DESCRIPTION OF THE RELATED ART

Field

Aspects of the present disclosure relate generally to data communication, and more particularly, to providing improved communication performance associated with the use of a resource shared for data communication.

Background

The utilization of data communication, whether by wireline or wireless communication links, has become commonplace in today's society. Various devices, such as personal computers (PCs), laptop computers, tablet devices, personal digital assistants (PDAs), smart phones, etc., are commonly used every day by individuals and businesses to communicate all forms of data, including electronic documents, voice data, video data, multimedia data, and the like. The aforementioned devices may communicate the foregoing data via a number of different interfaces associated with a number of different data sources, whether external or internal to the device.

As an example, often multiple data sources provide data flows within a system, whereby a particular resource, such as a buffer, is shared among the multiple data flows. For example, a particular device may comprise a system on a chip (SoC) architecture wherein the SoC architecture includes a long term evolution (LTE) modem providing a source of data, a wireless wide area network (WWAN) interface providing a source of data, and a wireless local area network (WLAN) interface providing a source of data. In operation of the device, each of these data sources may provide data flows to be delivered to a same data sink (e.g., host processor, operating system, application, etc. of the device) via a same buffer.

The shared use of the aforementioned buffer by the data flows of the multiple data sources may result in data packet loss. For example, all data packets for each of the data sources for which the data flows flow through a shared buffer are dropped when that buffer is full. These packet losses result in performance degradation of the system and reduced end-to-end throughput. In particular, as the input data rate gets closer to the output data rate, the effective throughput reduces.

In accordance with one example, at an input/output ratio of 0.5, the effective throughput of the shared buffer is close to 1 (i.e., there are no packet losses). However, as the input/output ratio increases to 0.9 in this example, the effective throughput of the shared buffer reduces to 0.95, implying a net packet loss rate of 5%.

One technique to address the foregoing problem may be to increase the buffer size. However, implementation costs increase significantly with the increase in the size of the buffers, particularly in SoC implementations. Moreover, the complexity of the implementation also increases when larger buffers are used. Likewise, adding additional buffers to the system significantly increases the complexity of the implementation. Accordingly, increasing the buffer size and/or adding additional buffers often does not provide a viable solution to the shared resource data packet loss problem.

### SUMMARY

In one aspect of the disclosure, a method for data communication including monitoring, by a packet gate coupled to an input of a shared resource, a number of chunks of a data packet received at the packet gate. The method of embodiments also includes passing, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows, and dropping, by the packet gate, all chunks of the data packet after the specified number of chunks of the data packet are passed on to provide recovery of the data packet from the passed chunks.

In an additional aspect of the disclosure, an apparatus for data communication includes means for monitoring, by a packet gate coupled to an input of a shared resource, a number of chunks of a data packet received at the packet gate. The apparatus of embodiments also includes means for passing, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows, and means for dropping, by the packet gate, all chunks of the data packet after the specified number of chunks of the data packet are passed on to provide recovery of the data packet from the passed chunks.

In an additional aspect of the disclosure, a non-transitory computer-readable medium having program code recorded thereon is disclosed. The program code according to some aspects includes code to cause a computer to monitor, by a packet gate coupled to an input of a shared resource, a number of chunks of a data packet received at the packet gate. The program code of embodiments also includes code to cause the computer to pass, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows, and to drop, by the packet gate, all chunks of the data packet after the specified number of chunks of the data packet are passed on to provide recovery of the data packet from the passed chunks.

In an additional aspect of the disclosure, an apparatus for data communication includes at least one processor and a memory coupled to the at least one processor, wherein the at least one processor is configured to monitor, by a packet gate coupled to an input of a shared resource, a number of chunks of a data packet received at the packet gate. The at least one processor of embodiments is also configured to pass, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows, and to drop, by the packet gate, all chunks of the data packet after the specified number of chunks of the data packet are passed on to provide recovery of the data packet from the passed chunks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A shows a system as may be adapted in accordance with the concepts of the present disclosure;

FIG. 1B shows additional detail with respect to a data sink of the system of FIG. 1A;

FIG. 2 shows a graph representing the effective throughput of a buffer 131 as a function of the ratio of the net input to output data rates;

FIG. 3 shows a system adapted to reduce packet losses associated with the use of a resource shared for data communication using a packet gate in accordance with the concepts of the present disclosure;

FIG. 4 shows a flow diagram of operation to provide reduction in data packet losses with respect to a shared resource utilizing a packet gate in accordance with the concepts of the present disclosure;

FIG. 5A shows an exemplary format of a data packet as may be utilized according to the concepts of the present disclosure;

FIG. 5B shows an exemplary format of a chunk as may be utilized according to the concepts of the present disclosure;

FIG. 6 shows a form of table as may be utilized to track the number of received encoded chunks according to the concepts of the present disclosure;

FIG. 7 shows a portion of the system of FIG. 3 modeled as a M/M/1/K queue; and

FIG. 8 show the effective available throughput as a function of the ratio of input to output rates for different numbers of repair symbols generated by the redundant data encoder of systems adapted according to the concepts of the present disclosure.

### DETAILED DESCRIPTION

The detailed description set forth below, in connection with the appended drawings, is intended as a description of various possible configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in data communications utilizing a shared resource, wherein communication performance is improved with respect to the shared resource utilizing a packet gate operable in accordance with the concepts herein. For example, a packet gate is utilized with respect to a shared resource to improve the effective throughput and/or reduce packet losses with respect to a plurality of data flows sharing the resource.

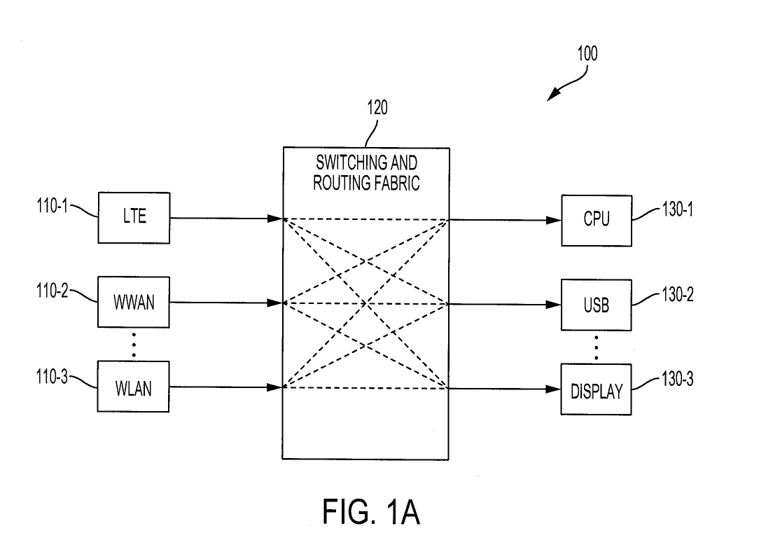

FIG. 1A shows a system as may be adapted in accordance with the concepts herein. The illustrated embodiment of system 100 shown in FIG. 1A includes a plurality of data sources, shown as data sources 110-1 through 110-3, and a plurality of data sinks, shown as data sinks 130-1 through 130-3, wherein the data sources are operable to provide data to any or all of the data sinks via a switching and routing fabric, shown as switching and routing fabric 120. The data sources may comprise any number of modules, circuits, apparatuses, etc., such as a LTE modem (e.g., data source 110-1), a WWAN interface (e.g., data source 110-2), a WLAN interface (e.g., data source 110-3), a network interface card (NIC) (not shown), a data storage device (not shown), an application program (not shown), etc., operable to output data directed to one or more data sinks. The data sinks may comprise any number of modules, circuits, apparatuses, etc., such as a central processing unit (CPU) (e.g., data sink 130-1), a universal serial bus (USB) interface or device (e.g., data sink 130-2), a display device (e.g., data sink 130-3), a NIC (not shown), a data storage device (not shown), an application program (not shown), etc., operable to receive data directed thereto from one or more data sources. The switching and routing fabric (e.g., switching and routing fabric 120) providing communication of data flows between the data sources and data sinks may comprise any number of configurations, including wired data paths, wireless links, active devices (e.g., switches, routers, repeaters, etc.), ports, etc.

The configuration of system 100 illustrated in FIG. 1A may, for example, correspond to functional blocks of a user device, such as a PC, laptop computer, tablet device, PDA, smart phone, etc. For example, system 100 may comprises a SoC architecture as implemented in embodiments of one or more of the foregoing user devices. It should be appreciated, however, that application of the concepts herein are not limited to such user devices. A system adapted according to the concepts herein may, for example, comprise data sources (e.g., user devices, web servers, base stations, access points, etc.) disposed remotely with respect to the corresponding data sinks (e.g., user devices, web servers, base stations, access points, etc.), wherein the switching and routing fabric comprises one or more networks (e.g., a personal area network (PAN), a local area network (LAN), a wide area network (WAN), the Internet, an extranet, an intranet, the public switched telephone network (PSTN), a cable transmission system, etc.).

It should be appreciated that, although three data sources and three data sinks are shown in the illustrated embodiment of system 100, different numbers of data sources and/or data sinks may be provided in accordance with the concepts herein. Moreover, there is no requirement that the number of data sources and the number of data sinks be the same. It should also be appreciated that the particular configuration of data sources and/or data sinks may differ from that of the illustrated embodiment. For example, the data sources may include wireline and/or wireless data sources, multiple instances of a same type or configuration of data source, etc. Similarly, the data sinks may include multiple instances of the same type or configuration of data sinks, a number of differently configured data sinks, a single data sink, etc.

Irrespective of the particular configuration of system 100, one or more resources may be shared with respect to data flows between the data sources and one or more data sinks, whereby the sharing of the resource is subject to data packet losses. For example, as shown in the further detail provided in FIG. 1B with respect to embodiments of data sink 130, as may correspond to any or all of data sinks 130-1 through 130-3 of FIG. 1A, buffer 131 provides a shared resource with respect to a plurality of data flows (e.g., flows 1-3) directed to data packet destination 132. It should be appreciated that, although data packet destination 132 illustrated in FIG. 1B is shown as being a terminal destination (e.g., a module, circuit, apparatus, etc. that is the ultimate consumer of the data), the data packet destination may instead comprise an intermediary destination (e.g., a module, circuit, apparatus, etc. that passes the data on to another data packet destination, perhaps after performing some level of processing upon the data).

In operation according to the embodiment illustrated in FIG. 1B, data packets from the multiple data sources arrive at data sink 130 as flows 1 through 3 and are each buffered by buffer 131 and then sent on to data packet destination 132. Accordingly, buffer 131 provides a shared resource with respect to these data flows and the data sources associated therewith.

It should be appreciated that, although the embodiment illustrated in FIG. 1B shows a buffer as a shared resource, the concepts herein are applicable with respect to additional or alternative shared resources. For example, shared resources for which packet loss reduction is provided according to embodiments herein may comprise any shared resource having a limited capacity (e.g., communication channel having limited throughput, a shared bus, etc.). Shared resources of embodiments may comprise various configurations, media, interfaces, etc. For example, a shared communication channel for which packet loss reduction is provided may comprise a wired or wireless channel, or combinations thereof (e.g., data sources may comprise one or more smartphones that are using the same radio frequency to communicate with a data sink, such as a network entity like an eNB).

As shown in the embodiment of FIG. 1B, buffer 131 provides the interface to data packet destination 132 for the data packets of each of flows 1 through 3. Thus, all data packets arriving at data sink 130 when buffer 131 is full are dropped. These data packet losses result in data communication performance degradation of the system and reduced end-to-end throughput. Consistent with the foregoing, various factors determine the data communication performance with respect to data sink 130. For example, the data rates of the individual flows, the rate at which data packets can be processed by the data packet destination and the buffer emptied, and the buffer size can all effect the data communication performance.

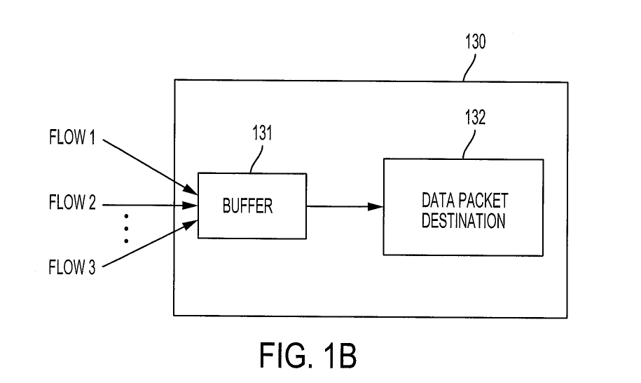

Graph 200 of FIG. 2 shows the typical effective throughput of buffer 131, for buffer size K=10, as a function of the ratio of the net input to output data rates. As can be seen in graph 200, as the net input data rate is increased and the input data rate approaches the output data rate, the effective throughput reduces. At an input/output ratio of 0.5, the effective throughput is close to 1 and there are no packet losses resulting from the shared use of buffer 131. However, as the net input rate increases to 0.9, the effective throughput of buffer 131 reduces to 0.95, implying a net packet loss rate of 5% associated with the shared use of buffer 131.

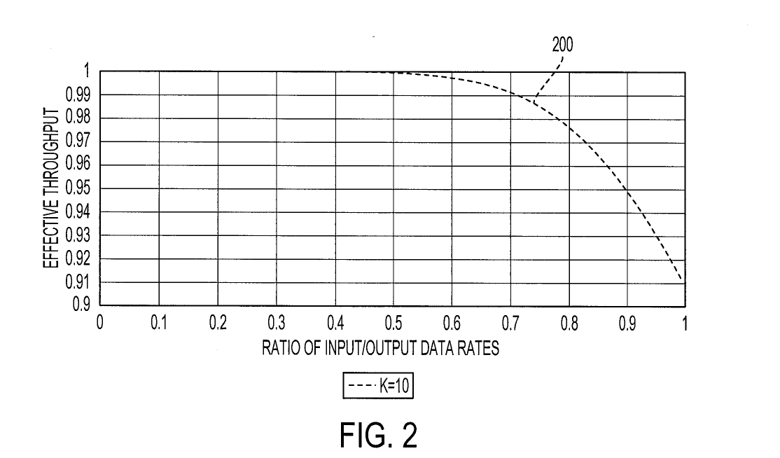

Embodiments implemented in accordance with concepts of the disclosure improve the effective throughput of a shared resource, such as buffer 131, and reduce packet losses associated with its shared use without requiring an increase with respect to attributes of the shared resource, such as without requiring increased buffer size. FIG. 3 shows system 300 adapted in accordance with the foregoing.

The embodiment of system 300 shown in FIG. 3 includes a plurality of data sources, shown as data sources 110-1 through 110-3 corresponding to the data sources of the implementation of FIG. 1A. Of course, different numbers and configurations of data sources may be utilized, if desired. The illustrated embodiment of system 300 also includes a data sink, shown as data sink 330, such as may correspond to any of data sinks 130-1 through 130-3 of FIG. 1A. It should be appreciated that, although a single data sink is shown for simplicity, any number of data sinks may be utilized as desired. As with system 100 discussed above, data sources 110 of system 300 are operable to provide data to data sink 330 via switching and routing fabric 120. However, the embodiment of system 300 is adapted to utilize data coding in combination with a packet gate disposed at an input to the shared resource to improve the effective throughput and reduce packet losses.

The illustrated embodiment of system 300 includes encoders 310-1 through 310-3 disposed in the data paths between each data source and the switching and routing fabric coupling the data sources to the shared resource, packet gate 320 disposed between the switching and routing fabric and the input to the shared resource, and decoder 331 disposed between the output of the shared resource and the data packet destination. It should be appreciated that, although the illustrated embodiment of system 300 shows packet gate 320 as being separate from data sink 330, packet gates implemented according to the concepts herein may be provided in configurations different than that shown, such as to be fully or partially integrated into a data sink. Similarly, although the shared resource (e.g., buffer 131) and corresponding decoder 331 are shown in the illustrated embodiment of system 300 as being integrated with data sink 330, this functionality may be provided in configurations different than that shown, such as to be fully or partially separated from a data sink. Also, although a single encoder or decoder is shown with respect to a particular data path, it should be appreciated that embodiments may implement different numbers of encoders and/or decoders, such as to provide a plurality of encoders/decoders operable to perform different coding techniques. Additionally or alternatively, a different number of packet gates may be provided with respect to a data sink than shown, such as to provide a plurality of packet gates where a plurality of shared resources are implemented with respect to a data sink.

Encoders 310-1 through 310-3 provide data redundancy encoding, such as through the use of forward error correction (FEC) encoding, with respect to the data of the respective flows. For example, encoders 310-1 through 310-3 may implement one or more erasure codes (e.g., tornado codes, low-density parity-check codes, Reed-Solomon coding, fountain codes, RAPTOR codes, RAPTORQ codes, and maximum distance separable (MDS) codes) whereby source data is broken into fragments (e.g., k source fragments for each source object such as data packets or other blocks of source data) and additional repair fragments (e.g., r repair fragments for each source object) are generated to provide a total number of fragments (e.g., n=k+r) greater than the source fragments. Accordingly, encoders 310-1 through 310-3 are shown as including data packet disassembly blocks, as may be operable to break the source data into the aforementioned fragments, and encoder blocks, as may be operable to perform the aforementioned data coding.

Correspondingly, decoder 331 provides decoding of the source data from the encoded data. For example, where FEC encoding is utilized as described above, decoder 331 may operate to recover the source object using any combination of k number of fragments (i.e., any combination of source fragments and/or repair fragments totaling k in number), or possibly k+x where x is some small integer value (e.g., 1 or 2) where a non-MDS code is used. Accordingly, decoder 331 is shown as including a decoder block, as may be operable to perform the aforementioned data decoding, and a packet assembly block, as may be operable to reassemble source objects from the decoded fragments.

Use of the aforementioned encoding facilitates a high probability of recovery of the data from some specified portion of the total number of encoded fragments, wherein the specified portion of encoded fragments is configured provide data recovery to a certain probability of success. For example, perfect recovery codes, such as MDS codes, facilitate recovery of the source data using any combination of k fragments (i.e., any combination of a number of source fragments and/or a number of repair fragments totaling k) to a very high probability (e.g., 100% probability of recovery). Similarly, some near perfect recovery codes, such as RAPTOR codes and RAPTORQ codes, facilitate recovery of the source data using any combination of k+x fragments (i.e., any combination of a number of source fragments and/or an number of repair fragments totaling k+x) to a high probability (e.g., 99.99% probability of recovery where x=1, 99.999% probability of recovery where x=2, etc.). In providing the foregoing data encoding, embodiments herein utilize RAPTORQ encoding in light of RAPTORQ being a near perfect erasure recovery code that provides a high probability of data recovery with very small encoding and decoding complexity, and thus is particularly well suited for implementation in some system configurations, such as SoC systems.

In operation of system 300 of the illustrated embodiment, data packets from a data source go through a “Packet Disassembly” process of a respective encoder 310 where the packets are broken up into smaller fixed size chunks suitable for transmission over the switching and routing fabric. FEC encoding is then applied by the respective encoder 310 to the foregoing chunks (e.g., using the aforementioned RAPTORQ encoding), whereby the encoding technique utilized allows recovery of data with some loss of data chunks in transmission. The encoded chunks are then sent into switching and routing fabric 120 to be routed to an appropriate data sink, such as data sink 330 (e.g., host processor, operating system, application, etc.).

Packet gate 320 of the illustrated embodiment, provided between the egress of the switching and routing fabric and an input of the shared resource, operates to keep track of the number of chunks of a packet that have been received. When logic of packet gate 320 determines that a specified number of chunks of a packet are received that are sufficient for the decoder to recover the packet with a high probability (e.g., k chunks or k+x chunks, a known number established by the encoding technique implemented), the packet gate drops all subsequent chunks of that packet. The chunks that are not dropped by the packet gate are passed through buffer 131 (i.e., the shared resource) for processing downstream by the respective decoder 331. Accordingly, at the output of the shared resource, the received chunks are processed by a “Packet Assembly” process of encoder 331 and the original packet assembled by encoder 331. The packet is then passed to data packet destination 132 of data sink 330.

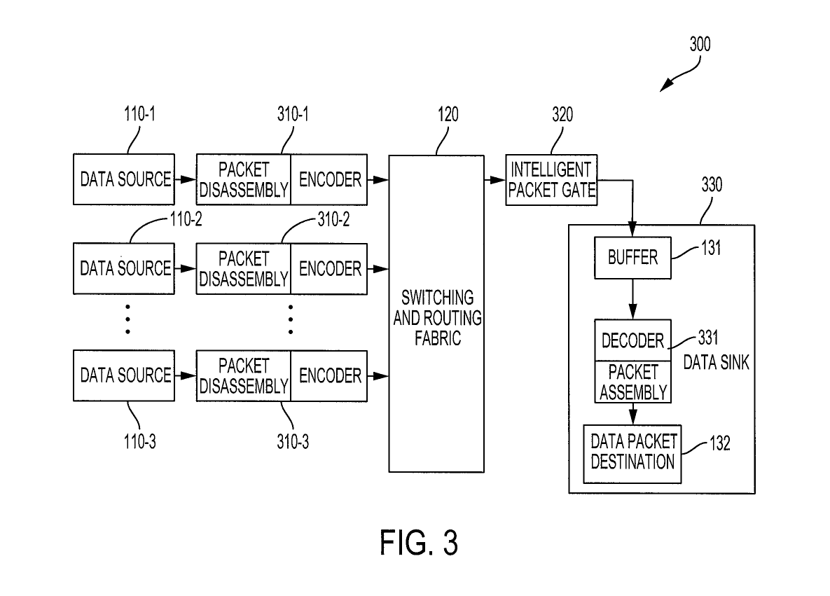

FIG. 4 shows a flow diagram of operation to provide reduction in data packet losses with respect to a shared resource utilizing a packet gate operable in accordance with the foregoing. In particular, in flow 400 illustrated in FIG. 4 blocks 401-404 set forth operation in accordance with embodiments of encoder 310, such as may correspond to any of encoders 310-1 through 310-3 of FIG. 3, blocks 405-409 set forth operation in accordance with embodiments of packet gate 320, and blocks 410-412 set forth operation in accordance with embodiments of decoder 331.

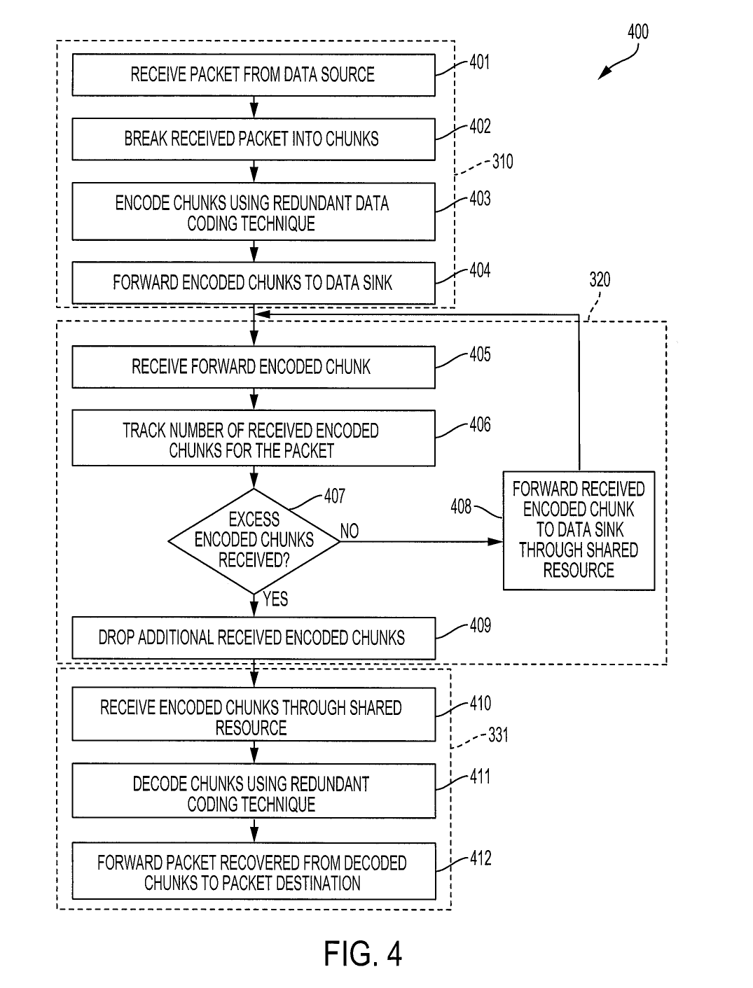

At block 401 of the illustrated flow, a data packet to be provided to data sink 330 is received from a data source by encoder 310. An exemplary format of a received data packet is shown in FIG. 5A, wherein data packet 500 of the illustrated embodiment comprises header portion 501 and payload portion 502. Header portion 501 may include various control and routing information, such as packet identification, source identification, destination identification, payload type, packet size, packet flow identification, etc., as is known in the art. Payload portion 502 may include the data (e.g., user content, digitized voice, digitized video, system control data, etc.) being conveyed via data packet 500, as is known in the art.

Logic of encoder 310 operates to disassemble the received data packet into chunks (e.g., k data packet portions of equal size) at block 402. An exemplary format of the resulting chunks is shown in FIG. 5B, wherein chunk 510 of the illustrated embodiment comprises packet identification 511, packet size 512, chunk identification 513, chunk count 514, and chunk data 515. Packet identification 511 may provide information identifying the packet, such as for use in determining the chunks corresponding to a particular packet. Packet identification information may be obtained from the received data packet, such as from information within packet header 501, and/or may be generated by encoder 310, such as by assigning a substantially unique number or other identification string to the received packet. Packet size 510 may provide information regarding the size of the received packet, such as may comprise the number of bytes of the original packet. Packet size information may be obtained from the received data packet, such as from information within packet header 501, and/or may be determined by encoder 310, such as by analyzing the received data packet. Chunk identification 513 may provide a substantially unique (substantially unique being sufficiently unique in use to provide the requisite level of identification correspondence for operation as described herein) identifier for the chunk. Chunk count 514 may provide information regarding the number of chunks (e.g., number of source chunks k or total number of encoded chunks n, wherein n=k+r) provided with respect to the corresponding packet. Chunk data 515 may include the portion of the packet data carried by the chunk.

The chunks of source data are provided to coding logic of encoder 310 for encoding the chunks using a redundant data coding technique (e.g., FEC encoding, such as RAPTORQ) at block 403 of the illustrated embodiment. For example, the coding logic may operate to generate a number of repair chunks (e.g., r) providing redundant data from which the data packet can be recovered from any combination of a predetermined number (e.g., k or k+x) of source chunks and repair chunks. It should be appreciated that, in operation according to embodiments, the chunk identification field may exceed the chunk count field when the chunk contains repair symbols generated by the encoding technique.

At block 404 of flow 400 shown in FIG. 4 encoder 310 operates to forward the encoded chunks to the appropriate data sink. For example, encoder 310 may direct the encoded chunks (e.g., k source chunks and r repair chunks) to the appropriate data sink through switching and routing fabric 120.

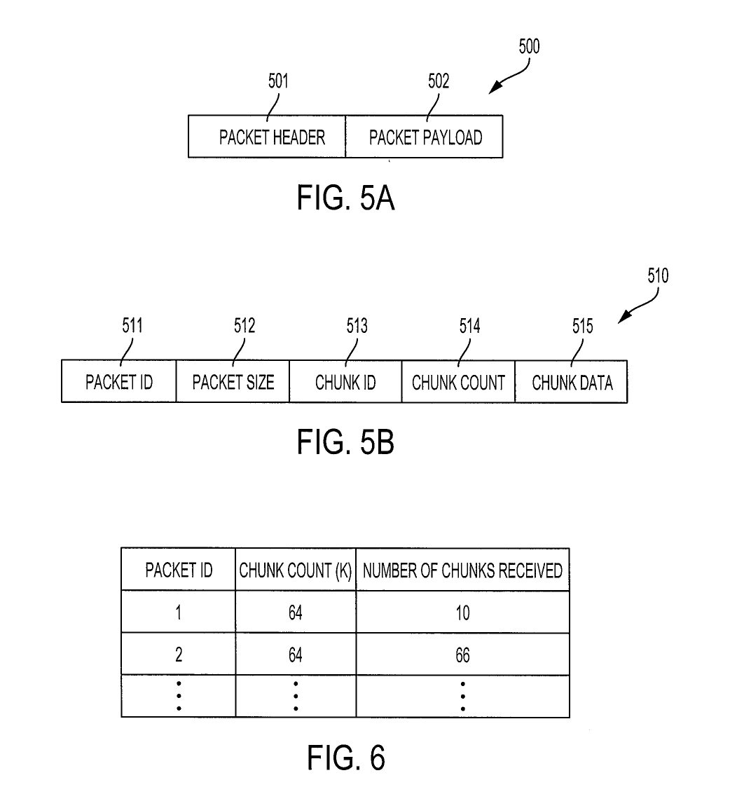

At block 405 of the illustrated flow, a forwarded encoded chunk to be provided to data sink 330 is received from encoder 310 by packet gate 320. In providing intelligent gating operation according to concepts herein, logic of packet gate 320 operates to track the number of received encoded chunks for each packet, as shown at block 406 of the illustrated embodiment. For example, packet gate 320 may track the number of received encoded chunks using a database or table as illustrated in FIG. 6, wherein the packet identification field provides identification information for the data packet to which the record pertains, the chunk count field provides information regarding the number of chunks for the particular data packet (i.e., the number of source chunks k in the illustrated example), and the number of chunks received field provides a running tally of the number of chunks received by the packet gate for the particular data packet. Accordingly, for each data packet, the table of FIG. 6 may be used to keep track of number of chunks of the packet received and the total chunk count needed. It should be appreciated that a table configuration such as that illustrated in FIG. 6 may be implemented in hardware or simple software modules.

Packet gate 320 of embodiments operates to pass encoded chunks on to the shared resource (e.g., buffer 131 of the embodiment illustrated in FIG. 3) for ultimate delivery to the data packet destination until a specified number of chunks of a packet facilitating a high probability of recovering the packet (e.g., k or k+x, a known number depending upon the encoding technique used) have been passed to the shared resource. Thereafter, packet gate 320 of embodiments drops subsequent chunks of that packet. Accordingly, logic of packet gate 320 operates at block 407 of the illustrated embodiment to determine if encoded chunks for a packet determined to facilitate recovery of the packet to a high probability (e.g., at least 99.99% probability of data recovery) have been received and passed on to the shared resource by packet gate 320 (i.e., the received encoded chunk is not needed for providing a high probability of recovery of the packet and is thus considered an excess encoded chunk by the packet gate). If a specified number of chunks of a packet for a high probability of recovery of the packet have not been received and passed to the shared resource (e.g., 10 chunks received for data packet 1 in FIG. 6, where k=64 and the number of chunks needed to recover a packet is k or k+x), processing according to the illustrated embodiment proceeds to block 408 where the received encoded chunk is passed to the shared resource. However, if a specified number of chunks of a packet for a high probability of recovery of the packet have been received and passed to the shared resource, and thus the received encoded chunk currently being analyzed is an excess encoded chunk (e.g., 66 chunks received for data packet 2 in FIG. 6, where k=64 and the number of chunks needed to recover a packet is k or k+x, x=1 or 2 in this example), processing according to the illustrated embodiment proceeds to block 409 wherein the excess received encoded chunks are dropped without passing them to the shared resource.

It should be appreciated that, although the illustrated flow of FIG. 4 shows independent analysis and forwarding of encoded chunks to the shared resource by the packet gate, embodiments of packet gate 320 may provide operation differing from that shown. For example, logic of packet gate may operate to analyze the received encoded chunks to identify those that are source chunks and those that are repair chunks and give priority to passing source chunks on to the shared resource. As an example, passing a source chunk rather than a repair chunk (thus operating to drop more repair chunks, in favor of passing more source chunks, than would otherwise be dropped by the packet gate) may be utilized to facilitate more rapid recovery of the packet by the decoder due to less data decoding processing being required to extract the source data from repair chunks. Such selection between source chunks and repair chunks may be implemented, for example, where encoded packets are received by the packet gate simultaneously or otherwise without substantial delay between the received chunks or where the packet gate operates to collect some number of received encoded chunks before passing chunks on to the shared resource.

The encoded chunks passed to the shared resource of the embodiment illustrated in FIG. 3 are buffered to be processed downstream by data packet destination 132. Accordingly, as data packet destination 132 consumes data, additional data is released from buffer 131 for providing to and processing by data packet destination 132. Accordingly, the encoded chunks are processed at the output of the shared resource by decoder 331 for recovering the packet to provide to data packet destination 132. Thus, at block 410 of flow 400 illustrated in FIG. 4, encoded chunks to be provided to data sink 330 are received from the shared resource by decoder 331.

The chunks of encoded data, as may comprise source chunks and/or repair chunks, provided through the shared resource are provided to decoding logic of decoder 331 for decoding the chunks using a redundant data coding technique (e.g., FEC encoding, such as RAPTORQ) at block 411 of the illustrated embodiment. For example, the decoding logic may operate to regenerate a packet from some portion of source chunks (e.g., some number of the k source chunks) and/or some number of repair chunks (e.g., some number of the r repair chunks), wherein the total number of encoded chunks (e.g., k or k+x) used to regenerate the data packet is determined by the particular coding technique utilized.

Thereafter, at block 412 of the illustrated embodiment, the recovered packets are forwarded by decoder 331 to data packet destination 132 for normal operation of the data packet destination. It should be appreciated that, although operation to provide reduction in data packet losses with respect to buffer 131, as may be shared among a number of data flows directed to data packet destination 132, utilizing packet gate 320 and associated encoding and decoding is implemented according to the illustrated embodiment, data processing as performed by data packet destination 132 may be performed without modification to accommodate the use of the packet gate. That is, operation of the packet gate of embodiments is transparent with respect to the data sources and data packet destination.

It should be appreciated that the operation of the aforementioned encoder, packet gate, and decoder are shown in flow 400 of the illustrated embodiment as being performed serially, some or all such operations or portions thereof may be performed in parallel. For example, the decoder may be receiving encoded chunks forwarded by the packet gate while the packet gate continues to receive forwarded encoded chunks and perform analysis with respect thereto. Similarly, the packet gate may perform operations to drop additional received encoded chunks while the decoder continues to receive previously forwarded encoded chunks. Accordingly, it can be appreciated that the operations shown in the illustrated embodiment of flow 400 may be performed in an order different than that shown.

It should also be appreciated that multiple instances of some or all of the operations of flow 400 may be performed, whether in parallel, serially, or independently. For example, the operations illustrated as being performed by encoder 310 (blocks 401-404) may be performed in parallel by a plurality of encoders (e.g., any or all of encoders 310-1 through 310-3) associated with data sources providing data to data sink 330. Additionally or alternatively, multiple instances of the operations of flow 400 may be performed in parallel, such as to provide reduction in data packet losses for a plurality of shared resources using a packet gate in accordance with the concepts herein.

In accordance with the foregoing operation of flow 400, performance improvements are gained by adding extra overhead using a redundant data encoder (e.g., FEC encoder). For example, using a near perfect coding technique with low encoding and decoding complexity, such as RAPTORQ, the system can tolerate larger data losses and still perform very well, such as to maintain an effective throughput of 1 (i.e., no packet loss) even when the ratio of input to output rate of the shared resource reaches 1.

In the aforementioned use of redundant data coding with a packet gate implementation, it can be appreciated that embodiments introduce an additional design parameter, wherein the additional design parameter is the amount of repair symbols generated by the redundant data encoder. This parameter, together with the shared resource attributes (e.g., buffer size) and input and output data rates, defines the performance of the system. Thus, although it seems counter-intuitive that performance improvements can be gained by adding extra overhead using a redundant encoder, systems implementing packet gates in accordance with the concepts herein can tolerate larger data losses and still perform very well.

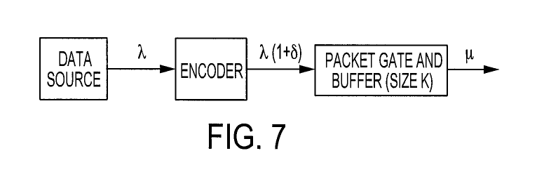

The following analysis illustrates the gains that can be achieved by implementations in accordance with the concepts herein. In analyzing the performance of a system implementation in accordance with embodiments herein, the system may be modeled as a simple M/M/1/K queue with an input data rate of λ, as shown in FIG. 7. The data rate is increased to k(1+δ) by the encoder (e.g., RAPTORQ encoder) of embodiments. Data at this data rate then enters the packet gate and buffer of size K, wherein the buffer is emptied at a rate μ. The effective rate of the system is λ(1+δ)(1−Pₖ) where

$${P}_{k} = \frac{{ρ}^{K} ( 1 - ρ )}{1 - {ρ}^{K + 1}}$$

and where (1+δ)(1−Pₖ)=1. If δ is chosen such that (1+δ)(1−Pₖ)=1, then the effective packet loss rate after the decoder becomes 0.

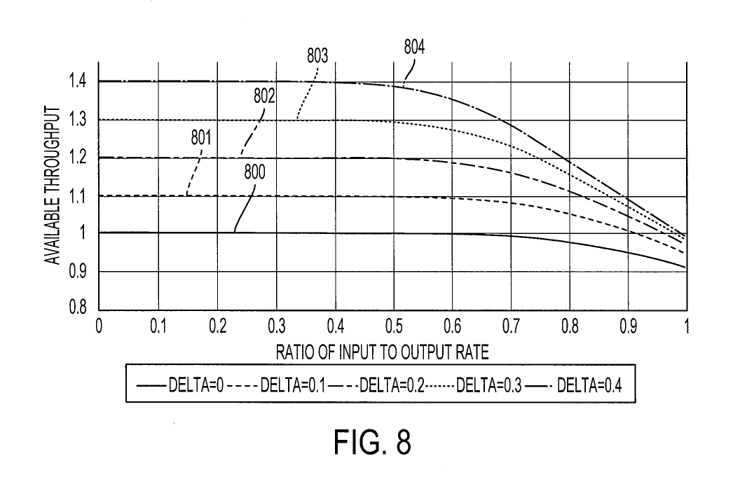

The graphs of FIG. 8 show the effective available throughput for systems adapted according to embodiments herein as a function of the ratio of input to output rates for different values of δ (e.g., graph 800 for δ=0, graph 801 for δ=0.1, graph 802 for δ=0.2, graph 803 for δ=0.3, and graph 804 for δ=0.4). As can be seen from graphs 800-804, when the ratio of input to output rate is small, there are very few packet losses and therefore the effective available throughput is almost 1. However, as the ratio of input to output rate increases, packet losses increase and the available throughput reduces. The available throughput improves as the number of repair symbols generated by the redundant data encoder (given by δ) is increased according to embodiments herein, as illustrated at the right side of graphs 800-804.

Accordingly, embodiments herein operate to select an amount of data encoding overhead to utilize based upon the incoming data rate and the rate of data output by the shared resource. Embodiments may thus dynamically select an amount of data encoding overhead to implement, such as to implement no or little data encoding overhead when the shared resource is not near its capacity and to increase the data encoding overhead as the shared resource approaches its capacity limit (e.g., buffer or channel throughput limit).

Although selected aspects have been illustrated and described in detail, it will be understood that various substitutions and alterations may be made therein without departing from the spirit and scope of the present disclosure.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIG. 3 may comprise processors, electronics devices, hardware devices, electronics components, logical circuits, memories, software codes, firmware codes, etc., or any combination thereof. The operations of FIG. 4, or some portion thereof, may be implemented as program code, such as in the form of instructions or data structures, that can be executed a general-purpose or special-purpose computer, or a general-purpose or special-purpose processor, and/or as logic components of the various functional blocks of FIG. 3.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of tangible storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use embodiments in accordance with concepts of the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for data communication, the method comprising:
monitoring, by a packet gate coupled to an input of a shared resource, a number of chunks of a data packet received at the packet gate;
passing, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows; and
dropping, by the packet gate, all chunks of the data packet after the specified number of chunks of the data packet are passed on to provide recovery of the data packet from the passed chunks.

2. The method of claim 1, further comprising:
receiving the data packet from a first data source;
breaking the data packet into a plurality of chunks; and
encoding the plurality of chunks using a redundant data encoding technique to provide a plurality of encoded chunks, wherein the chunks of the data packet received at the packet gate and passed to the shared resource comprise encoded chunks of the plurality of encoded chunks.

3. The method of claim 2, wherein the redundant data encoding technique comprises a forward error correction (FEC) encoding technique.

4. The method of claim 2, wherein the redundant data encoding technique comprises an erasure recovery code that requires a number of encoded chunks greater than a number of the plurality of chunks the data packet is broken into in order to provide a determined probability of recovery of the data packet.

5. The method of claim 2, further comprising:
selecting an amount of data encoding overhead utilized by the data encoding technique based upon an incoming data rate of the plurality of data flows and a rate of data output by the shared resource.

6. The method of claim 5, wherein the selecting an amount of data encoding overhead comprises:
increasing the amount of data encoding overhead utilized by the data encoding technique as the shared resource approaches a capacity limit.

7. The method of claim 6, wherein the shared resource comprises a buffer and the capacity limit comprises a buffer capacity of the buffer.

8. The method of claim 2, further comprising:
receiving the encoded chunks passed by the packet gate to the shared resource from an output of the shared resource;
decoding the encoded chunks to recover the data packet; and
passing the data packet recovered from the encoded chunks to a data sink.

9. The method of claim 8, further comprising:
receiving a second data packet from a second data source, wherein the second data packet comprises a data packet of a second data flow of the plurality of data flows;
breaking the second data packet into a second plurality of chunks;
encoding the second plurality of chunks using the redundant data encoding technique to provide a second plurality of encoded chunks;
monitoring, by the packet gate, a number of second encoded chunks of the second plurality of encoded chunks of the second data packet received at the packet gate;
passing, by the packet gate, the second encoded chunks on to the shared resource until a specified number of second encoded chunks of the second data packet are passed on to provide recovery of the second data packet from the passed second encoded chunks;
dropping, by the packet gate, all second encoded chunks of the second data packet after the specified number of second encoded chunks of the second data packet are passed on to provide recovery of the second data packet from the passed second encoded chunks;
receiving the second encoded chunks passed by the packet gate to the shared resource from the output of the shared resource;
decoding the second encoded chunks to recover the second data packet; and
passing the second data packet recovered from the second encoded chunks to the data sink.

10. The method of claim 9, wherein the passing and dropping of the encoded chunks and the second encoded chunks by the packet gate increases an effective throughput of the shared resource.

11. An apparatus for data communication, the apparatus comprising:
means for monitoring, by a packet gate coupled to an input of a shared resource, a number of chunks of a data packet received at the packet gate;
means for passing, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows; and
means for dropping, by the packet gate, all chunks of the data packet after the specified number of chunks of the data packet are passed on to provide recovery of the data packet from the passed chunks.

12. The apparatus of claim 11, further comprising:
means for receiving the data packet from a first data source;
means for breaking the data packet into a plurality of chunks; and
means for encoding the plurality of chunks using a redundant data encoding technique to provide a plurality of encoded chunks, wherein the chunks of the data packet received at the packet gate and passed to the shared resource comprise encoded chunks of the plurality of encoded chunks.

13. The apparatus of claim 12, further comprising:
means for selecting an amount of data encoding overhead utilized by the data encoding technique based upon an incoming data rate of the plurality of data flows and a rate of data output by the shared resource.

14. The apparatus of claim 12, further comprising:
means for receiving the encoded chunks passed by the packet gate to the shared resource from an output of the shared resource;
means for decoding the encoded chunks to recover the data packet; and
means for passing the data packet recovered from the encoded chunks to a data sink.

15. The apparatus of claim 14, further comprising:
means for receiving a second data packet from a second data source, wherein the second data packet comprises a data packet of a second data flow of the plurality of data flows;
means for breaking the second data packet into a second plurality of chunks;
means for encoding the second plurality of chunks using the redundant data encoding technique to provide a second plurality of encoded chunks;
means for monitoring, by the packet gate, a number of second encoded chunks of the second plurality of encoded chunks of the second data packet received at the packet gate;
means for passing, by the packet gate, the second encoded chunks on to the shared resource until a specified number of second encoded chunks of the second data packet are passed on to provide recovery of the second data packet from the passed second encoded chunks;
means for dropping, by the packet gate, all second encoded chunks of the second data packet after the specified number of second encoded chunks of the second data packet are passed on to provide recovery of the second data packet from the passed second encoded chunks;
means for receiving the second encoded chunks passed by the packet gate to the shared resource from the output of the shared resource;
means for decoding the second encoded chunks to recover the second data packet; and
means for passing the second data packet recovered from the second encoded chunks to the data sink.

16. A non-transitory computer-readable medium having program code recorded thereon, the program code comprising:
program code for causing a computer to:
monitor, by a packet gate coupled to an input of a shared resource, a number of chunks of a data packet received at the packet gate;
pass, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows; and
drop, by the packet gate, all chunks of the data packet after the specified number of chunks of the data packet are passed on to provide recovery of the data packet from the passed chunks.

17. The non-transitory computer-readable medium of claim 16, wherein the program code is further for causing the computer to:
receive the data packet from a first data source;
break the data packet into a plurality of chunks; and
encode the plurality of chunks using a redundant data encoding technique to provide a plurality of encoded chunks, wherein the chunks of the data packet received at the packet gate and passed to the shared resource comprise encoded chunks of the plurality of encoded chunks.

18. The non-transitory computer-readable medium of claim 17, wherein the program code is further for causing the computer to:
select an amount of data encoding overhead utilized by the data encoding technique based upon an incoming data rate of the plurality of data flows and a rate of data output by the shared resource.

19. The non-transitory computer-readable medium of claim 17, wherein the program code is further for causing the computer to:
receive the encoded chunks passed by the packet gate to the shared resource from an output of the shared resource;
decode the encoded chunks to recover the data packet; and
pass the data packet recovered from the encoded chunks to a data sink.

20. The non-transitory computer-readable medium of claim 19, wherein the program code is further for causing the computer to:
receive a second data packet from a second data source, wherein the second data packet comprises a data packet of a second data flow of the plurality of data flows;
break the second data packet into a second plurality of chunks;
encode the second plurality of chunks using the redundant data encoding technique to provide a second plurality of encoded chunks;
monitor, by the packet gate, a number of second encoded chunks of the second plurality of encoded chunks of the second data packet received at the packet gate;
pass, by the packet gate, the second encoded chunks on to the shared resource until a specified number of second encoded chunks of the second data packet are passed on to provide recovery of the second data packet from the passed second encoded chunks;
drop, by the packet gate, all second encoded chunks of the second data packet after the specified number of second encoded chunks of the second data packet are passed on to provide recovery of the second data packet from the passed second encoded chunks;
receive the second encoded chunks passed by the packet gate to the shared resource from the output of the shared resource;
decode the second encoded chunks to recover the second data packet; and
pass the second data packet recovered from the second encoded chunks to the data sink.

21. An apparatus for data communication, the apparatus comprising:
at least one processor; and
a memory coupled to the at least one processor, wherein the at least one processor is configured:
to monitor, by a packet gate coupled to an input of a shared resource, a number of chunks of a data packet received at the packet gate;
to pass, by the packet gate, the chunks on to the shared resource until a specified number of chunks of the data packet are passed on to provide recovery of the data packet from the passed chunks, wherein the shared resource comprises a resource shared by a plurality of data flows, and wherein the data packet comprises a data packet of a first data flow of the plurality of data flows; and
to drop, by the packet gate, all chunks of the data packet after the specified number of chunks of the data packet are passed on to provide recovery of the data packet from the passed chunks.

22. The apparatus of claim 21, wherein the at least one processor is further configured:
to receive the data packet from a first data source;
to break the data packet into a plurality of chunks; and
to encode the plurality of chunks using a redundant data encoding technique to provide a plurality of encoded chunks, wherein the chunks of the data packet received at the packet gate and passed to the shared resource comprise encoded chunks of the plurality of encoded chunks.

23. The apparatus of claim 22, wherein the redundant data encoding technique comprises a forward error correction (FEC) encoding technique.

24. The apparatus of claim 22, wherein the redundant data encoding technique comprises an erasure recovery code that requires a number of encoded chunks greater than a number of the plurality of chunks the data packet is broken into in order to provide a determined probability of recovery of the data packet.

25. The apparatus of claim 22, wherein the at least one processor is further configured:
to select an amount of data encoding overhead utilized by the data encoding technique based upon an incoming data rate of the plurality of data flows and a rate of data output by the shared resource.

26. The apparatus of claim 25, wherein the at least one processor configured to select an amount of data encoding overhead is further configured:
to increase the amount of data encoding overhead utilized by the data encoding technique as the shared resource approaches a capacity limit.

27. The apparatus of claim 26, wherein the shared resource comprises a buffer and the capacity limit comprises a buffer capacity of the buffer.

28. The apparatus of claim 22, wherein the at least one processor is further configured:
to receive the encoded chunks passed by the packet gate to the shared resource from an output of the shared resource;
to decode the encoded chunks to recover the data packet; and
to pass the data packet recovered from the encoded chunks to a data sink.

29. The apparatus of claim 28, wherein the at least one processor is further configured:
to receive a second data packet from a second data source, wherein the second data packet comprises a data packet of a second data flow of the plurality of data flows;
to break the second data packet into a second plurality of chunks;
to encode the second plurality of chunks using the redundant data encoding technique to provide a second plurality of encoded chunks;
to monitor, by the packet gate, a number of second encoded chunks of the second plurality of encoded chunks of the second data packet received at the packet gate;
to pass, by the packet gate, the second encoded chunks on to the shared resource until a specified number of second encoded chunks of the second data packet are passed on to provide recovery of the second data packet from the passed second encoded chunks;
to drop, by the packet gate, all second encoded chunks of the second data packet after the specified number of second encoded chunks of the second data packet are passed on to provide recovery of the second data packet from the passed second encoded chunks;
to receive the second encoded chunks passed by the packet gate to the shared resource from the output of the shared resource;
to decode the second encoded chunks to recover the second data packet; and
to pass the second data packet recovered from the second encoded chunks to the data sink.

30. The apparatus of claim 29, wherein passing and dropping of the encoded chunks and the second encoded chunks by the packet gate increases an effective throughput of the shared resource.
